(19) United States
(12) Patent Application Publication
(10) Pub. No.: US 2021/0180173 A1
(43) Pub. Date: Jun. 17, 2021

(54) MECHANICALLY ALLOYED METALLIC THERMAL SPRAY COATING MATERIAL AND THERMAL SPRAY COATING METHOD UTILIZING THE SAME

(71) Applicant: OERLIKON METCO (US) INC., Westbury, NY (US)

(72) Inventors: Gregory SZYNDELMAN, Villigen (CH); Scott WILSON, Zurich (CH)

(73) Assignee: OERLIKON METCO (US) INC., Westbury, NY (US)

(21) Appl. No.: 16/772,695

(22) PCT Filed: Dec. 13, 2018
(86) PCT No.: PCT/US18/65424

§ 371 Date: Jun. 12, 2020

Related U.S. Application Data
(60) Provisional application No. 62/599,409, filed on Dec. 15, 2017.

(51) Int. Cl. C23C 4/067; C22C 21/02; B22F 3/115; C23C 4/129; C23C 4/131; C23C 4/134; B22F 1/00

(52) U.S. Cl. CPC C23C 4/067; C22C 21/02; B22F 3/115; B22F 2007/042; C23C 4/131; C23C 4/134; B22F 1/0011; C23C 4/129

(57) ABSTRACT

Thermal sprayed coating made from a thermal spray powder material containing aluminum containing particles mechanically alloyed to a transition metal. The coating includes aluminum alloy portions alloyed to the transition metal. The thermal spray powder is made of aluminum containing particles mechanically alloyed to a transition metal.

### CROSS-REFERENCE TO RELATED APPLICATIONS

The instant application claims priority under 35 U.S.C. § 119(e) of U.S. provisional Patent Application No. 62/599,409 filed on Dec. 15, 2017. The disclosure of which is expressly incorporated by reference herein in its entirety.

### STATEMENT REGARDING SPONSORED RESEARCH OR DEVELOPMENT

Not Applicable.

### BACKGROUND OF THE INVENTION

### Field of the Invention

The invention is a metallic based thermal spray coating with improved sliding and wear properties and which is made from a thermal spray powder that includes one or more transition metals, e.g., molybdenum or molybdenum and chromium, that is/are mechanically alloyed to a metallic based material such as aluminum or aluminum alloy. A coating method is also disclosed.

### Description of Related Art

Thermal spray coating materials are known and are typically metallic and/or ceramic powder materials. Some of these powder materials offer wear and corrosion resistance when used to form thermal spray coatings.

Corrosion of coating materials can be observed by the presence of chlorides as well as of galvanic couples in the case of materials such as steel, stainless steels, titanium alloys and Nickel alloys. Typical corrosion types include galvanic corrosion, stress corrosion cracking, atmospheric corrosion and aqueous corrosion which can lead to catastrophic failures such as coating blistering, and spallation.

Wear damage typically arises from excessive frictional forces (high coefficient of friction) and frictional heating. The damage can take the form of metal transfer and scuffing, extreme bulk plastic deformation, and even fracture.

Mechanical alloying of metallic powder with transition metals is also known and has been studied for decades. However, they are typically used to manufacture parts via sintering consolidation treatments. The use of mechanical alloying of transition metals allows for an increase in the concentration of such transition elements in, for example, an aluminum alloy, which can produce a de-facto solid solution.

Aluminum alloy based powder coatings are also known. These include abradable powder coating materials. Examples include: Metco 601NS which utilizes Aluminum (Al) with 7 percent Silicon (Si) and 40 percent polyester and METCO® 320NS which utilizes Aluminum (Al) with 10 percent Silicon (Si) and 20 percent hexagonal boron nitride (hBN).

The use of Aluminum alloy based thermal spray powders to produce abradable coatings for clearance control applications are also known. These are employed where a rotating component may come into contact with the coating as a result of design intent or operational surges. These coatings are designed to minimize the wear to the rotating components while maximizing gas path efficiency by providing clearance control in seal areas. Such coatings typically combine desired properties of polymeric materials such as soft shearable and heat resistant polyesters with higher strength shearable alloys (e.g. METCO® 601NS or M610NS which is Al-bronze+polyester). Another coating concept combines Al—Si with hBN where the ceramic hBN phase acts to facilitate cutting performance and boost temperature resistance (METCO® 320NS). These coatings are suited for rub incursions against either steel, nickel alloy or Titanium alloy compressor blades, knives or labyrinth seal strips.

Abradable coatings with Aluminum alloy matrices are, however, known to be susceptible to general corrosion (white aluminum hydroxide generation), cyclic corrosion, blistering corrosion as well as stress-corrosion cracking damages, when exposed to sea salt and moisture laden environments.

It is also known that metal-to-metal transfer phenomena can be seen for aluminum alloys which are used as the major component of lightweight turbine clearance control coatings (abradables), commonly result in unwanted grooving or “gramophoning” effects produced on the shroud materials (abradables) under some turbine rotor incursion conditions. The term “transfer” here means the tendency of aluminum alloys to adhere and build up on other surfaces, in this case the turbine blades manufactured from titanium or stainless-steel alloys. Other commonly used engineering terms for transfer are “galling” or “cold welding” or on a larger and industrially significant scale, friction welding. Galling phenomena are only partially understood, however two major factors that promote galling of metals and alloys when in contact with other surfaces are (a) Metals & alloys with a high chemical activity and (b) Metals & alloys with a low shear modulus & shear strength (see Buckley, Donald H., Journal of Colloid and Interface Science, 58 (1), p. 36-53, January 1977 “The metal-to-metal interface and its effect on adhesion and friction”, Buckley, Donald H., Thin Solid Films, 53 (3), p. 271-283, September 1978 “Tribological properties of surfaces,” and Miyoshi, Kazuhisa/Buckley, Donald H., Wear, 82 (2), p. 197-211, November 1982 “Tribological properties of silicon carbide in the metal removal process”). The entire disclosure of each of these documents is herein incorporated by reference.

Lower shear strength aluminum and alloys thereof, will tend to transfer to higher strength metal surfaces (e.g. Titanium alloy turbine engine blade tips in the case of clearance control with aluminum). Both aluminum and titanium alloys have high chemical activities and oxidize very rapidly. Both form protective oxide layers on their surfaces, which will tend to inhibit material transfer effects, but these get broken up and removed, especially on softer, lower shear strength aluminum alloys, when the surface undergoes deformation on frictional contact. The breakup of protective oxide layers and other adsorbed gas layers (e.g. water) assists the adhesive transfer (galling) process by exposing the unprotected alloy to high strain rate plastic deformation, friction welding and mechanical mixing at the contact interface. This has also been clearly demonstrated by observing the friction behavior of metals under high vacuum where the formation and replenishment of oxide layers is inhibited and there are no protective oxides or adsorbed gas layers to prevent transfer and galling phenomena (see Miyoshi, Kazuhisa, Buckley, Donald H, Wear, 77, Issue 2, April 1982, Pages 253-264 “Adhesion and friction of transition metals in contact with non-metallic hard materials”). The entire disclosure of this document is herein incorporated by reference.

In the case of a high-speed rotating turbine rotor blade tip (e.g. 100-400 m/s tip velocity range), once a lump or asperity of transferred aluminum alloy has adhered to the opposing blade tip surface it will act as an extension to the blade tip and produce a groove on the opposing abradable surface on the next blade incursion step into the shroud. The result is a dynamic process of shear deformation and localization of the aluminum alloy, mechanical mixing, heat generation, oxidation, abrasion, transfer, further grooving and cutting, and removal of the transfer layer once the shear-stresses at the blade tip interface, or within the transfer layer itself, become too high. The resultant steady state mechanism is a complex balance between each of these different mechanisms, that is determined overall by the turbine rotor incursion conditions into the abradable shroud. Typically, low rotor tip speed conditions (e.g. 100-200 m/s) are conducive to transfer phenomena and grooving (gramophoning) where the rate of aluminum alloy transfer is higher than that of its removal by shear cutting stresses on the tip; the cutting force induced shear stresses being insufficient to break the interface of aluminum that is friction welded to the blade tip metal. The undesired effect of grooving and gramophoning phenomena is that it increases both shroud and blade tip surface roughness's and open the tip-shroud gap clearances, thereby impacting negatively on turbine sealing efficiency. Subsequent cooling down of turbine blade tips to ambient temperatures after an incursion event or engine cycle commonly results in the transferred aluminum to break off the tips due to thermal expansion mismatch stresses and relaxation of residual stresses imparted in the transferred aluminum layers during the heavy deformation processes. This results in even higher sealing efficiency losses. Smoother surfaces for both shroud and blade tip are ideal for improved sealing efficiency and gas flow aerodynamics.

In order to reduce the grooving or gramophoning phenomena, the metal-to-metal transfer process needs to be inhibited. Various methods can be introduced to effect this, the most common being by inclusion of solid lubricant materials such as graphite or hexagonal boron nitride (hBN), or other similar materials into the coating microstructures (see S. Wilson The Future of Gas Turbine Technology, 6th International Conference, 17-18 Oct. 2012, Brussels, Belgium, Paper ID Number 51 “Thermally sprayed abradable coating technology for sealing in gas turbines”). The entire disclosure of this document is herein incorporated by reference. These are effective in helping to some extent yet are somewhat inefficient as metal-to-metal transfer inhibitors in that they can be only handled as micro structurally large particles which only partly and inefficiently lubricate and protect the exposed aluminum alloy matrix. In addition, while solid lubricants such as graphite and hBN are well known anti-stick materials, they are also combustible (graphite) and friable and tend to inhibit the formation of metal-to-metal bonding in the thermal spray deposition process, with the result that microstructural control can become difficult.

Other approaches used include the introduction of harder microstructural phases into the aluminum alloy that help to inhibit the transfer of aluminum to blade tips, by micro-abrasive removal of material on the blade tip surfaces. This is commonly done by increasing the silicon content of the aluminum alloys from hypoeutectic to near eutectic compositions. Silicon has a hardness of 900-1000HV and is therefore abrasive towards softer materials. However, there are limits to how much silicon content can be increased due to the risk of having too much abrasion on turbine blades.

A further approach which leads to the embodiment of the current invention is to modify the surfaces of aluminum alloy powder particles by introducing a mechanically stable thin layer on them that is made from a material with high lubricity and in turn, helps to inhibit metal-to-metal transfer effects (galling). Here thin layers of a solid with high lubricity could possibly be deposited onto aluminum alloys using a number of techniques, such as by physical vapor deposition (PVD e.g. sputter coating), ion implantation or laser heating (see R. J. Rodriguez, A. Sanz, A. Medrano, Ja. Garcia-Lorente Vacuum Volume 52, Issues 1-2, 1 January 1999, Pages 187-192 “Tribological properties of ion implanted Aluminum alloys”). The entire disclosure of this document is herein incorporated by reference. However, these techniques are not very practical or economically feasible for coating aluminum alloy particles on a mass production scale. Another approach is to clad finely milled lubricous material(s) onto aluminum alloy particles using an organic or inorganic binder (see J. R. Davis Handbook of Thermal Spray Technology ASM International, 2004, P157 “Material Production Techniques for Producing Unique Geometries of Compositions”). The entire disclosure of this document is herein incorporated by reference. However, this approach is also not practical as the adhesion of the clad layer of fine particles is dependent on the adhesive strength of the binder used which is commonly weak and affected by higher temperatures. Ideally if the lubricous material layer could be physically welded or alloyed to the surfaces of the particles, it would help their mechanical stability for both thermal spray handling and flow, spray deposition and their function as a mechanically stable lubricous layer in for example contact against a turbine blade. One approach is to use mechanically alloying techniques to alloy a thin layer of lubricous material particles to the aluminum alloy particles. This can be tried using well known lubricous materials such as hexagonal boron nitride or graphite, but these materials have very low shear strengths and will not weld or alloy to the particle surfaces. Another approach is to mechanically alloy the particle surfaces with a lubricous material that also readily welds to aluminum alloys. In this respect, molybdenum metal is a material that stands out in having good lubricity and readily mechanically alloys with aluminum alloys (see M. Zdujic, D. Poleti, Lj. Karanovic, K. F. Kobayashi, P. H. Shingu Materials Science and engineering, A185 (1994) 77-86 “Intermetallic phases produced by the heat treatment of mechanically alloyed Al—Mo powders”). The entire disclosure of this document is herein incorporated by reference.

Molybdenum is well known for its excellent lubricity and use in sliding and fretting wear applications to reduce friction in many engineering systems e.g. automotive piston ring coatings (see V. Anand, S. Sampath, C. D. Davis, D. L. Houck U.S. Pat. No. 5,063,021 “Method for preparing powders of nickel alloy and molybdenum for thermal spray coatings”. The entire disclosure of this document is herein incorporated by reference. Molybdenum is frequently quoted as having excellent wear properties imparted by a high hardness (see M. Laribi, A. B. Vannes, D. Treheux Wear Volume 262, Issues 11-12, 10 May 2007, Pages 1330-1336 “Study of mechanical behavior of molybdenum coating using sliding wear and impact tests”). The entire disclosure of this document is herein incorporated by reference. In fact, the hardness of pure molybdenum in the bulk state (sintered from powder) is actually very soft for a “highly wear resistant” material, sitting at approximately 230 HV (see T. S. Srivatsan, B. G. Ravi, A. S. Naruka, L. Riester, M. Petraroli, T. S. Sudarshan, Powder Technology 114, 2001. 136-144 “The microstructure and hardness of molybdenum powders consolidated by plasma pressure compaction”). The entire disclosure of this document is herein incorporated by reference. It has been shown that the wear resistance of Molybdenum-based coatings can be further improved when blending pure Molybdenum with bronze and/or Al12Si powder and/or mixtures thereof (see J. Ahn, B. Hwang, S. Lee, Journal of Thermal Spray Technology, Volume 14(2) June 2005-251 “Improvement of Wear Resistance of Plasma-Sprayed Molybdenum Blend Coatings”). The entire disclosure of this document is herein incorporated by reference. When molybdenum is sprayed as a coating (e.g. wire arc, HVOF or plasma) it tends to partly oxidize, with the result that oxygen and oxide inclusions can harden it significantly to easily produce hardnesses in the range 600-950HV, thereby imparting improved wear resistance (see S. Tailor, A. Modi, S. C. Modi, J Therm Spray Tech, April 2018, Volume 27, Issue 4, pp 757-768, “High-Performance Molybdenum Coating by Wire-HVOF Thermal Spray Process”). The entire disclosure of this document is herein incorporated by reference.

The low hardness in the purer, low oxygen content state and inherent brittleness, typical of refractory metals, make such molybdenum ideal for mechanical milling to a very fine submicron powders without the need for high energy input. Alloying of elemental Aluminum and Molybdenum using high energy milling and followed by consolidation treatments such as compaction and sintering was shown to produce corrosion resistant supersaturated aluminum alloys. However, these consolidation treatments to produce bulk materials were not able to preserve the corrosion resistant microstructure developed by high energy ball milling (see M. Zdujic, D. Poleti, Lj. Karanovic, K. F. Kobayashi, P. H. Shingu Materials Science and engineering, A185 (1994) 77-86 “Intermetallic phases produced by the heat treatment of mechanically alloyed Al—Mo powders” and W. C. Rodriguesa, F. R. Mallqui Espinoza, L. Schaeffer, G. Knörnschild, Materials Research, Vol. 12, No. 2, 211-218, 2009 “A Study of Al—Mo Powder Processing as a Possible Way to Corrosion Resistant Aluminum-Alloys”). The entire disclosure of each of these documents is herein incorporated by reference. Mechanical alloying followed by high frequency induction heat sintering was also found to be a viable technique to produce nanocrystalline transition metal-containing Aluminum alloys with excellent resistance to corrosion in 3.5% NaCl solution (see A. H. Seikh, M. Baig, H. R. Ammar, M. Asif Alam “The influence of transition metals addition on the corrosion resistance of nanocrystalline Al alloys produced by mechanical alloying”). The entire disclosure of this document is herein incorporated by reference. The above-noted references citing mechanical alloying of Aluminum with transition metals consisted of elemental powders mechanically alloyed and consolidated to produce bulk Aluminum alloys with higher strength and improved corrosion and wear resistance.

Radio frequency magnetron sputtering was another method used where metal films of alloyed Aluminum and Molybdenum with different Molybdenum content have been produced. By immersing the produced Al—Mo alloyed metal films in a chloride solution, the alloying with Molybdenum had the effect to catalyze the cathodic half-reaction and produce a rapid increase in the corrosion potential driving the critical pitting potential to more electropositive (see W. C. Moshier, G. D. Davis, J. S. Ahearn, H. F. Hough “Corrosion Behavior of Aluminum-Molybdenum Alloys in Chloride Solutions”). The entire disclosure of this document is herein incorporated by reference.

The superior corrosion resistance of Aluminum-Molybdenum alloys was also explained by the higher corrosion potential for alloys produced using electrodeposition (see T. Tsuda, C. L. Hussey, G. R. Stafford 2004 The Electrochemical Society “Electrodeposition of Al—Mo Alloys from the Lewis Acidic Aluminum Chloride-1-ethyl-3-methylimidazolium Chloride Molten Salt”). The entire disclosure of this document is herein incorporated by reference. Other studies have shown that Aluminum alloys containing transition metals (e.g. Cobalt and Molybdenum) and rare earth (e.g. Cerium) metal alloys exhibited superior corrosion resistance due to the release of Ce, Co and/or Mo ions acting as corrosion inhibitors (see M. A. Jakab, J. R. Scully “Cerium, Cobalt and Molybdate Cation Storage States, Release and Corrosion Inhibition when delivered from Al-Transition Metal-Rare Earth Metal Alloys”). The entire disclosure of this document is herein incorporated by reference.

One form of coating deposited by thermal spraying is a corrosion resistant abradable aluminum alloy such as disclosed in C. W. Strock, M. R. Jaworoski, F. W. Mase US published application 2016/0251975A1 “Aluminum alloy coating with rare earth and transition metal corrosion inhibitors.” The entire disclosure of this document is herein incorporated by reference. This application describes a thermally sprayed aluminum alloy coating where rare earth and transition metals are incorporated to the coating by infiltration and/or by using an atmospheric plasma co-spraying method.

None of the above-noted prior art disclosures, however, describe a metallic based thermal spray coating with improved sliding and wear properties and which is made from a thermal spray powder that includes one or more transition metals, e.g., molybdenum or molybdenum and chromium, that is/are mechanically alloyed to a metallic based material such as aluminum or aluminum alloy or a coating method that uses the powder.

### SUMMARY OF THE INVENTION

The invention encompasses an aluminum based thermal spray coating powder incorporating one or more transition metals such as molybdenum (Mo) and/or chromium (Cr) that have been mechanically alloyed with the aluminum alloy component and that can be used to form an abradable coating that can advantageously have improved wear and corrosion resistance.

Applicant has discovered that aluminum alloy based abradable coatings made using mechanically alloyed transition metals (e.g. Molybdenum and Chromium) and aluminum alloy powder exhibit excellent corrosion resistance—which is seen as an additional benefit. It is believed that the thermal spraying of mechanically alloyed powder enhances the alloying of the sprayed powder such that the applied coating exhibits excellent properties over current thermal spray coatings made out of atomized powder.

Embodiments of the invention include a metallic based thermal spray coating with improved sliding and wear properties wherein the coating material is made by mechanically alloying a metallic powder with one or more transition metals. Embodiments of the coating material include pure or alloyed aluminum, e.g., 99% pure aluminum, such as METCO® 54NS or aluminum with a purity greater than 98% or greater. In other examples, the purity can be either 90% or greater or 95% or greater. Embodiments of the transition metal or metals include Molybdenum, Chromium, Zirconium, Titanium, Silicon and mixtures thereof.

The invention is also directed to a thermal sprayed coating made from a thermal spray powder material containing aluminum containing particles mechanically alloyed to a transition metal, said coating comprising aluminum alloy portions alloyed to the transition metal.

Non-limiting embodiments include the aluminum containing particles each comprising an aluminum or aluminum alloy core surrounded by the transition metal mechanically alloyed to said core. The thermal spray powder may comprise an organic material or solid lubricant blended or mixed or clad with the aluminum containing particles. The aluminum containing particles may comprise a core of pure aluminum. The aluminum containing particles may comprise a core of an aluminum alloy.

The transition metal may be at least one of: Molybdenum; Chromium; and/or Molybdenum and Chromium. The transition metal may be only Molybdenum. The transition metal may be only Chromium or may be only both Mo and Cr. The mechanically alloyed transition metal has a particle size that is one of below 50 μm (Fisher Model 95 Sub-Sieve Sizer (FSSS) measurement), or below 10 μm (FSSS measurement), or below 1 μm (FSSS measurement).

The invention also includes a thermal spray powder coating material containing aluminum containing particles mechanically alloyed to a transition metal. In non-limiting embodiments, the aluminum containing particles each comprise an aluminum or aluminum alloy core surrounded by the transition metal mechanically alloyed to said core. The thermal spray powder may comprise an organic material or solid lubricant blended or mixed or clad with the aluminum containing particles. The aluminum containing particles may comprise a core of pure aluminum. The aluminum containing particles may comprise a core of an aluminum alloy.

The transition metal may be at least one of Molybdenum, Chromium, and/or may include both Mo and Cr. The transition metal may be only Molybdenum. The transition metal may be only Chromium or both Mo and Cr. The mechanically alloyed transition metal has a particle size that is one of below 50 μm (FSSS measurement), or below 10 μm (FSSS measurement), or below 1 μm (FSSS measurement).

The aluminum containing particles may be blended or clad with 20 to 70 weight percent organic material. The aluminum containing particles may be blended or clad with 30 to 50 weight percent organic material. The organic material is one of a polyester such as liquid crystal polyester, or polymer such as methyl methacrylate. The aluminum containing particles may be blended or clad with 5 to 50 weight percent solid lubricant. The aluminum containing particles may be blended or clad with 15 to 25 weight percent solid lubricant. The solid lubricant may be one of: hexagonal boron nitride; or calcium fluoride.

The invention also provides for a method of coating a substrate with a thermal spray powder coating material described above, wherein the method comprises thermal spraying the powder material onto the substrate, wherein thermal spray comprises: Plasma Spraying; High Velocity Oxyfuel (HVOF); or Combustion Spraying.

The invention also provides for a method of making the thermal spray powder coating material described above, wherein the method comprises mechanically alloying a transition metal to powder particles containing aluminum. In embodiments, the transition metal is Molybdenum. The transition metal may be Chromium or both Mo and Cr. The mechanically alloyed transition metal may have a particle size that is one of: below 50 μm (FSSS measurement); or below 10 μm (FSSS measurement), or below 1 μm (FSSS measurement).

The powder particle containing aluminum may be blended or clad with organic material. The powder particles may be blended or clad with one of: a polyester such as liquid crystal polyester; or polymer such as methyl methacrylate. The powder particles may be blended or mixed or clad with a solid lubricant.

The invention also provides for a thermal sprayed abradable coating made from a thermal spray powder material containing aluminum containing particles mechanically alloyed to a Molybdenum (Mo) and/or Chromium (Cr), said coating comprising aluminum alloy portions alloyed to the Mo and/or Cr. The aluminum containing particles may each comprise an aluminum or aluminum alloy core surrounded by the Mo metal mechanically alloyed to said core. The thermal spray powder material may comprise an organic material or solid lubricant blended or mixed or clad with the aluminum containing particles.

The invention also provides for a thermal spray powder abradable coating material comprising aluminum containing particles mechanically alloyed to a Molybdenum (Mo) and/or Cr. The aluminum containing particles may each comprise an aluminum or aluminum alloy core surrounded by the Mo and/or Cr metal mechanically alloyed to said core. The thermal spray powder abradable coating material may comprise an organic material or solid lubricant blended or mixed or clad with the aluminum containing particles.

The invention also includes a thermal spray powder coating material containing aluminum containing particles mechanically alloyed to a transition metal that is either Mo or Mo and Cr. In non-limiting embodiments, the aluminum containing particles each comprise an aluminum or aluminum alloy core surrounded by the transition metal mechanically alloyed to said core. The thermal spray powder also includes Si blended or mixed or clad with the aluminum containing particles. The composition is one of items 2-6 as listed on Table B described below. The aluminum containing particles may comprise a core of pure aluminum. The aluminum containing particles may comprise a core of an aluminum alloy.

### BRIEF DESCRIPTION OF THE DRAWINGS

The accompanying drawings are included to provide further understanding of the invention and are incorporated in and constitute a part of this specification. The accompanying drawings illustrate embodiments of the invention and together with the description serve to explain the principles of the invention. In the figures:

FIG. 1 shows an exemplary powder coating particle having an aluminum core and a transition metal that is mechanically alloyed to the core;

FIG. 2 shows how a coating material can be made by combining or mixing the coating particles of FIG. 1 with particles of a synthetic resin material such as polyester;

FIG. 3 shows an exemplary powder coating particle having a core of aluminum and silicon and with a transition metal that is mechanically alloyed to the core;

FIG. 4 shows how a coating material can be made by combining or mixing the coating particles of FIG. 3 with particles of a synthetic resin material such as polyester;

FIG. 5 shows an SEM picture at a first scale of a coating section of Al 12S1 and illustrates aluminum particles surrounded by a transition metal of Molybdenum (lighter shading surrounding particle) and showing polyester particles (darker shading);

FIG. 6 shows an SEM picture at a second scale of a coating section of Al 12S1 and illustrates a core particle (labeled) surrounded by a transition metal (labeled) and showing polyester particles (labeled);

FIG. 7 shows an SEM picture of a coating section of Al 12S1 and illustrates labeled aluminum particles surrounded by a transition metal of Molybdenum (lighter shading surrounding particle) and labeled showing polyester particles (darker shading);

FIG. 8 shows a chart comparing the compositions 1-6 of Table B subjected to abradability under the specified conditions;

FIG. 9 shows a wear track profile of the composition 1 of Table B;

FIG. 10 shows a wear track profile of the composition 2 of Table B;

FIG. 11 shows a wear track profile of the composition 3 of Table B;

FIG. 12 shows a wear track profile of the composition 4 of Table B;

FIG. 13 shows a wear track profile of the composition 5 of Table B;

FIG. 14 shows a wear track profile of the composition 6 of Table B;

FIG. 15 shows a chart listing five conditions for abradability tests;

FIG. 15A shows a chart for abradability of composition 1;

FIG. 15B shows a chart for abradability of composition 2;

FIG. 15C shows a chart for abradability of composition 3;

FIG. 15D shows a chart for abradability of composition 4;

FIG. 16 shows a chart comparing the compositions 1-4 of Table B subjected to immersion testing under the specified conditions;

FIG. 17 shows a cross-section of a coating made with composition 1 after immersion testing;

FIG. 18 shows a cross-section of a coating made with composition 3 after immersion testing; and

FIG. 19 shows two cross-sections at different scales of a coating made with composition 5.

### DETAILED DESCRIPTION OF THE INVENTION

The following detailed description illustrates by way of example, not by way of limitation, the principles of the disclosure. This description will clearly enable one skilled in the art to make and use the disclosure, and describes several embodiments, adaptations, variations, alternatives and uses of the disclosure, including what is presently believed to be the best mode of carrying out the disclosure. It should be understood that the drawings are diagrammatic and schematic representations of exemplary embodiments of the disclosure and are not limiting of the present disclosure nor are they necessarily drawn to scale.

The novel features which are characteristic of the disclosure, both as to structure and method of operation thereof, together with further aims and advantages thereof, will be understood from the following description, considered in connection with the accompanying drawings, in which an embodiment of the disclosure is illustrated by way of example. It is to be expressly understood, however, that the drawings are for the purpose of illustration and description only, and they are not intended as a definition of the limits of the disclosure.

In the following description, the various embodiments of the present disclosure will be described with respect to the enclosed drawings. As required, detailed embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, such that the description, taken with the drawings, making apparent to those skilled in the art how the forms of the present disclosure may be embodied in practice.

As used herein, the singular forms “a,” “an,” and “the” include the plural reference unless the context clearly dictates otherwise. For example, reference to “a powder material” would also mean that mixtures of one or more powder materials can be present unless specifically excluded. As used herein, the indefinite article “a” indicates one as well as more than one and does not necessarily limit its referent noun to the singular.

Except where otherwise indicated, all numbers expressing quantities used in the specification and claims are to be understood as being modified in all examples by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range (unless otherwise explicitly indicated). For example, if a range is from about 1 to about 50, it is deemed to include, for example, 1, 7, 34, 46.1, 23.7, or any other value or range within the range.

As used herein, the terms “about” and “approximately” indicate that the amount or value in question may be the specific value designated or some other value in its neighborhood. Generally, the terms “about” and “approximately” denoting a certain value is intended to denote a range within ±5% of the value. As one example, the phrase “about 100” denotes a range of 100±5, i.e. the range from 95 to 105. Generally, when the terms “about” and “approximately” are used, it can be expected that similar results or effects according to the disclosure can be obtained within a range of ±5% of the indicated value.

As used herein, the term “and/or” indicates that either all or only one of the elements of said group may be present. For example, “A and/or B” shall mean “only A, or only B, or both A and B”. In the case of “only A”, the term also covers the possibility that B is absent, i.e. “only A, but not B”.

The term “at least partially” is intended to denote that the following property is fulfilled to a certain extent or completely.

The terms “substantially” and “essentially” are used to denote that the following feature, property or parameter is either completely (entirely) realized or satisfied or to a major degree that does not adversely affect the intended result.

The term “comprising” as used herein is intended to be non-exclusive and open-ended. Thus, for example a composition comprising a compound A may include other compounds besides A. However, the term “comprising” also covers the more restrictive meanings of “consisting essentially of” and “consisting of”, so that for example “a composition comprising a compound A” may also (essentially) consist of the compound A.

The various embodiments disclosed herein can be used separately and in various combinations unless specifically stated to the contrary.

The invention is a metallic based thermal spray coating with improved sliding and wear properties wherein the coating material is made from a mechanically alloyed metallic powder that includes one or more transition metals. A coating method is also disclosed.

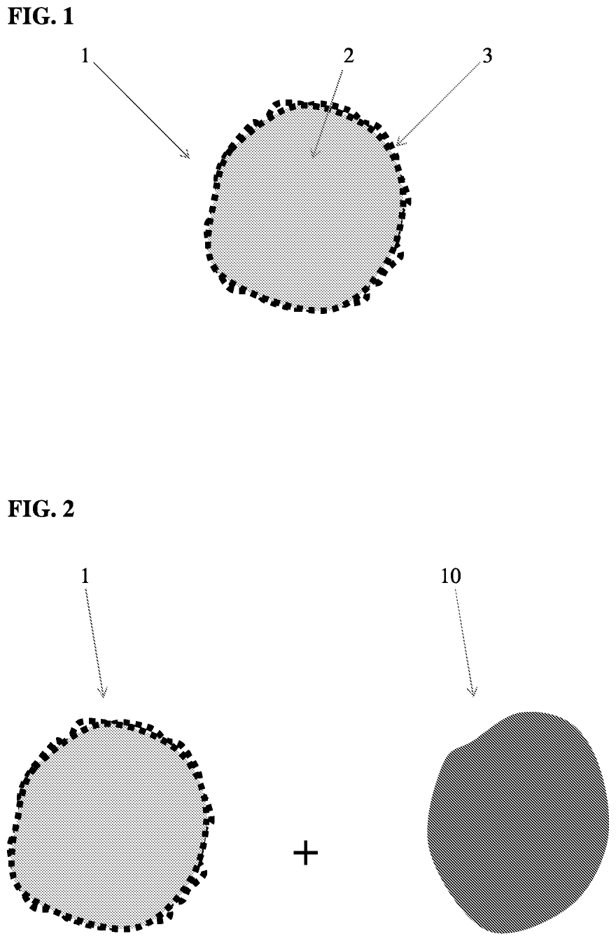

An embodiment of the invention is an abradable thermal spray coating powder which is made from powder particles of the type shown in FIG. 1 and which exhibits improved cutting performance and aims to eliminate wear damage on components such: as titanium alloy compressor blades (such as those used in the compressor section of aero-engine or land-based gas or steam turbine); and steel based compressor blades (compressor section of aero-engine or land-based gas or steam turbine).

Abradable seals can particularly benefit from the inventive coating. Such seals are used in turbo machinery to reduce the clearance between rotating components such as blades and labyrinth seal knife edges and the engine casing. Reducing the clearance improves the turbine engine's efficiency and reduces fuel consumption by allowing designers to reduce clearance safety margins by eliminating the possibility of a catastrophic blade/case rub. The compressor seal is produced by applying an abradable coating to the stationary part of the engine with the rotating part (blade, knife) rubbing against the coating.

By using the powder material shown in FIG. 1 to form an abradable coating on the above-noted components one should expect to see reduced galling as well as reduce propensity for so-called blade pick-up.

A side benefit of this material is improved corrosion performance. As was noted above, Aluminum alloy based abradable coatings are susceptible to general corrosion, cyclic corrosion (white hydroxide generation), blistering corrosion as well as stress-corrosion cracking damages, especially in sea salt moisture environments. However, in accordance with the invention, it has been demonstrated that Aluminum alloy based abradable coatings made using mechanically alloyed transition metals (e.g. Molybdenum and Chromium) exhibit excellent corrosion resistance—which is seen as an additional benefit.

Improvements in wear resistance of the inventive coating have also been demonstrated especially in the context compressor blades which are subject to damage from phenomena such as corrosion, galling, fretting and overall sliding wear. Typical coatings of which the invention offers improved wear resistance include: Aluminum based materials (METCO® 54NS, METCO® 52C-NS, Amdry 355), Titanium based materials (Pure Titanium and alloys powder available from Oerlikon Metco portfolio), Magnesium based as well as Copper based (DIAMALLOY® 1007, METCO® 445, METCO® 51F-NS, DIAMALLOY® 54, METCO® 57NS, METCO® 58NS). These thermal spray coating materials are susceptible to wear damages of which embodiments of the invention are not.

Referring again to FIG. 1, one can see that the powder particles 1 which will form the thermal spray coating material include an aluminum core 2 that is coated with a transition metal 3 such as Mo and/or Cr. The transition metal 3, in the form of much finer or smaller sized particles, is coated onto the core 2 by mechanical alloying. Mechanical alloying has been demonstrated to be an efficient and low-cost alloying process that produces a surface layer on powder particles.

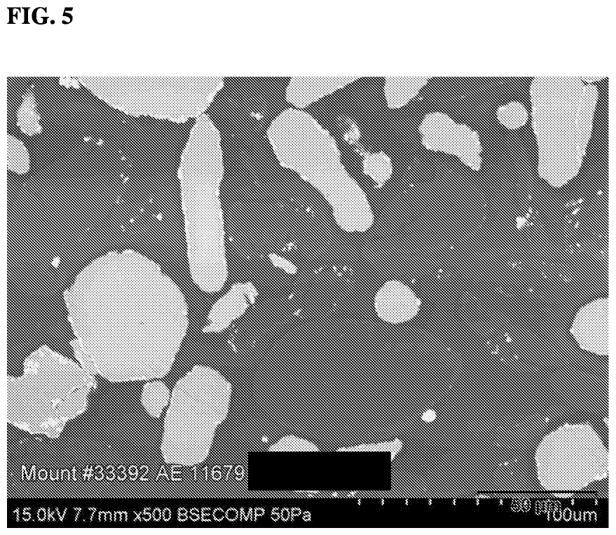

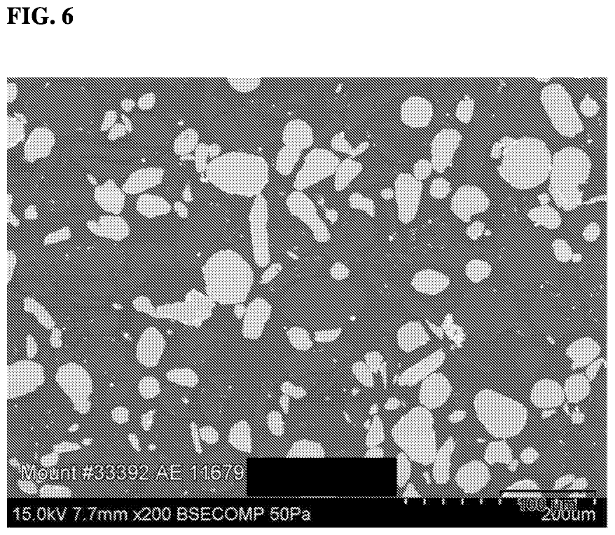

The alloying of the core 2 and transition metal 3 is enhanced by employing thermal spray. When the above-noted mechanically alloyed powder material is subjected to thermal spraying, the energy input from plasma spray partially melts and alloys (rapid solidification solution) the metallic particles with the transition metal. This is because these elements have extremely low solubility in given metallic matrices (e.g. Al) at temperatures below the melting point of Aluminum (e.g. 661° C.) and Aluminum Silicon alloys. The coating thus employs a two-stage alloying process. In a first stage, fine particles of transition metal such as Mo and/or Cr are mechanically alloyed with the outer surface of the metal particle such as Al via a mechanical alloying process which results in metal particles having a core of metal or metal alloy surrounded by a mechanically alloyed thin outer layer of transition metal. When such powder particles are subjected to heat energy such as from plasma spraying, this heat energy melts the metal particle with the thin layer of transition metal. When such particles are deposited as a coating, they form a coating of alloyed portions similar to that shown in FIGS. 5 and 6.

Because of the very low solubility of high melting point transition metals with the significantly lower melting point aluminum core it is essential that the amount of transition elements used to coat the particle cores is kept as low as practically possible to assist dissolution of the transition metal into the surface of the core particle using the heat energy provided by the thermal spray plasma. A transition element layer on the core that is too thick or that is comprised of particles that are too coarse will tend produce an alloy or composite material that is too hard and abrasive to be useful as an abradable.

Thermal spraying is thus an efficient way to enhance further alloying when mechanically alloyed particles pass through the high temperature plume jet of plasma. One can thus view the mechanical alloying as a first stage alloying of the core 2 and transition metal 3 and the thermal spraying as a second or final stage alloying of the core 2 and transition metal 3 to produce a solid solution, or partial supersaturated solid solution.

Referring to FIG. 2, one can see that the particles 1 can be mixed with particles 10 of polymer such as polyester. Non-limiting weight percentages of this mixture can be about 40 weight percent polymer and a balance of the mechanically allowed powder. This mixed powder can then be plasma sprayed on to a substrate to form a coating.

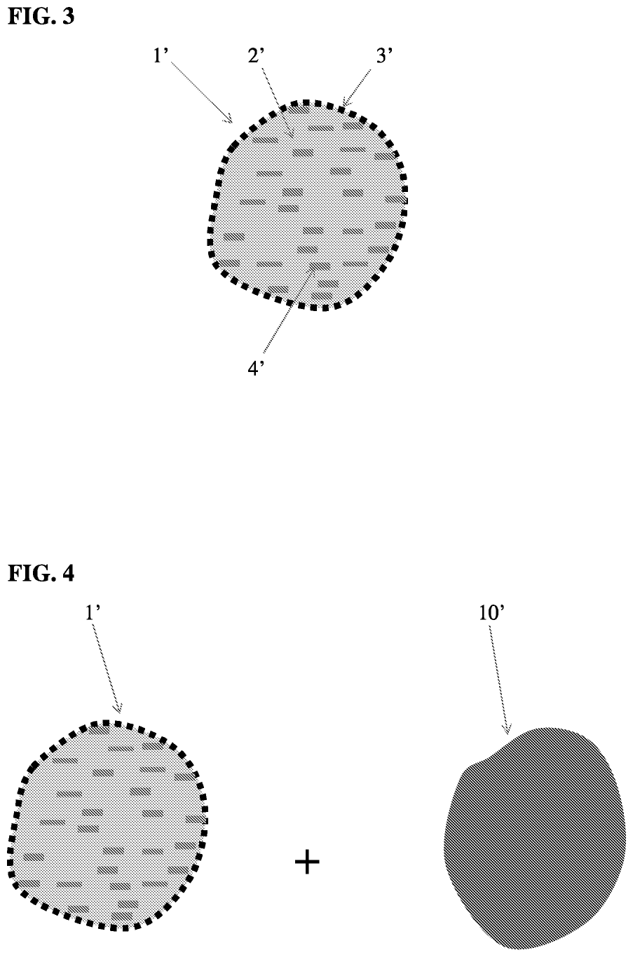

Referring to FIG. 3, one can see that the particles 1′ which will form the thermal spray coating material can also include an aluminum core 2′ having discrete sections of silicon 4′ and this core is coated with a transition metal 3′ such as Mo and/or Cr. The transition metal 3′ is coated onto the core 2′/4′ by mechanical alloying. Mechanical alloying has been demonstrated to be an efficient and low-cost alloying process that produces a surface layer on powder particles.

Referring to FIG. 4, one can see that the particles 1′ can be mixed with particles 10 of polymer such as polyester. Non-limiting weight percentages of this mixture can be about 40 weight percent polymer and a balance of the mechanically allowed powder that includes Si.

Experiments have been conducted with an available Al 12Si based coating powder (having a configuration similar to FIG. 3) which was modified so as to be mechanically alloyed with a Molybdenum containing solid solution alloy. The presence of Silicon in the Al 12Si allowed Mo to react with Si to form Mo-silicides. The thermal sprayed coating exhibited improved abradability and corrosion resistance.

Experiments were also carried out in order to study abradable coating powder compositions for low pressure compressor (LPC) section components, i.e., components used in the LPC of a turbine engine. The aim was to file thermal spray powder compositions that exhibit improved abradability performance and corrosion resistance over that of previously described Oerlikon Metco coatings. Typical temperatures observed in the LPC section are in the range of 350° C. maximum but may exceed this range in next generation of turbine engines.

The following thermal spray powder materials were analyzed:

Example A—includes 7 weight percent Si, 3 weight percent Mo, 3 weight percent Cr, 40 weight percent Polymer, and a balance of Al.

Example B—includes 6 weight percent Si, 2.7 weight percent Mo, 2.7 weight percent Cr, 46 weight percent Polymer, and a balance of Al.

Example C—includes 7 weight percent Si, 6 weight percent Mo, 40 weight percent Polymer, and a balance of Al.

Example D—includes 7 weight percent Si, 1 weight percent Mo, 1 weight percent Cr, 40 weight percent Polymer, and a balance of Al.

The abovementioned experimental powders were prepared using a mechanical alloying (ball milling) machine. An aluminum silicon alloy atomized powder was milled with one or more transition metals, or mixture thereof. The transition metals (Molybdenum and Chromium) had a fisher sub sieve sizer (FSSS) particle size below 10 μm.

Examples A-D were then compared to different materials such as Metco 601NS: Al 7Si 40 Polyester, Metco 320NS: Al 10Si 20hBN and Metco 52C-NS: Al 12Si.

Examples A-D were used to form abradable coatings as follows. The abradable powders A-D were deposited on a bind coat layer of Metco 450NS (NiAl) after this bond coat was applied to either a stainless steel (17-4PH) or Titanium alloy substrate. All bond coats were sprayed to a thickness of between 150 and 200 μm and each top coat of abradable coating was sprayed to a total coating thickness of 2.0 mm and then milled down. All tests were performed on the milled surface and no further surface preparation was performed. For each powder type, some coupons were prepared for hardness, metallography, erosion, bond strength and incursion (abradability) testing.

The different tests conducted on the exemplary coatings A-D were compared to the above-noted Metco products and were found to produce coatings with superior and improved properties. These properties included improved abradability (reduced galling and blade pick-up as well as no Titanium alloy blade wear) and corrosion resistance (NaCl wet corrosion environment). Additional details can be seen in the examples listed in Table A discussed later on.

The results of such experiments demonstrate that the mechanical alloying of transition metals with metal based alloy powder increases the solubility of these elements into different metallic matrices (e.g. Aluminum). Thermal spraying of such alloyed powder enhances alloying and solubility further leading to improved sliding and overall wear and corrosion properties. These improvements were demonstrated for Aluminum based abradable coatings where the cutting performance of such coatings when rubbed by Titanium alloy compressor blades was found to be highly superior to that of existing Aluminum based abradable coatings noted herein. Use of metallic abradable coatings made from transition metal containing mechanically alloyed powder was also found to reduce the galling behavior of the inventive abradable coatings and reduce the propensity to so-called blade pick-up. Another demonstrated side benefit is improved corrosion performance of Aluminum alloy based abradable coatings which are normally susceptible to general corrosion (white aluminum hydroxide generation), cyclic corrosion, blistering corrosion as well as stress-corrosion cracking damages, especially in sea salt moisture environments. It was demonstrated that Aluminum alloy based abradable coatings made using mechanically alloyed transition metals (e.g. Molybdenum and Chromium) containing Aluminum alloy powder exhibit excellent corrosion resistance.

### Example A

A powder coating material made of metal particles 1′ and polymer particles 10′ with particles 1′ being blended with particles 10′. Particles 1′ have a core 2′ is made of 7 weight percent Si (Si sections 4′) and a balance of Al. The transition metal 3′ is made of 3 weight percent Mo and 3 weight percent Cr. The particles 10′ constitute 40 weight percent Polymer. The particles 1′ have a size that ranged between 11 μm and 150 μm. The particles 10′ have a size that ranged between 45 μm and 150 μm.

### Example B

A powder coating material made of particles 1′ blended with particles 10′ wherein the particles 1′ have a core 2′ is made of 6 weight percent Si (Si sections 4′) and a balance of Al. The transition metal 3′ is made of 2.7 weight percent Mo and 2.7 weight percent Cr. The particles 10′ constitute 46 weight percent Polymer. The particles 1′ have a size that ranged between 11 μm and 150 μm. The particles 10′ have a size that ranged between 45 μm and 150 μm.

### Example C

A powder coating material made of particles 1′ blended with particles 10′ wherein the particles 1′ have a core 2′ is made of 7 weight percent Si (Si sections 4′) and a balance of Al. The transition metal 3′ is made of 6 weight percent Mo. The particles 10′ constitute 40 weight percent Polymer. The particles 1′ have a size that ranged between 11 μm and 150 μm. The particles 10′ have a size that ranged between 45 μm and 150 μm.

### Example D

A powder coating material made of particles 1′ blended with particles 10′ wherein the particles 1′ have a core 2′ is made of 7 weight percent Si (Si sections 4′) and a balance of Al. The transition metal 3′ is made of 1 weight percent Mo and 1 weight percent Cr. The particles 10′ constitute 40 weight percent Polymer. The particles 1′ have a size that ranged between 11 μm and 150 μm. The particles 10′ have a size that ranged between 45 μm and 150 μm.

TABLE A

| | | General | Blistering |
|---|---|---|---|
| | Incursion | Corrosion | Corrosion |
| | performance | resistance | resistance 200 |
| Thermally | Incursion | 200 hours | hours |
| sprayed | vs Titanium | immersion in | immersion in |
| abradable | alloy blades | 5 wt. % aqueous | 5 wt. % aqueous |
| coating | at set incursion | NaCl solution | NaCl solution |
| composition | conditions* | at 40° C. | at 40° C. |
| Al12Si + | Presence of | white | Blistering and |
| 40 wt % | adhesive transfer | aluminium | delamination |
| aromatic | of shroud material | hydroxide | cracking |
| polyesters | to blade and | corrosion | of coating |
| | grooving in shroud | product | present |
| | tips wear track | formation | |
| | Average over- | | |
| | penetration*: 39% | | |
| Examples A, B, | Reduced adhesive | No corrosion | No blistering |
| C and D | transfer of | product | or |
| AlSi—Mo or | shroud material | (aluminium | delamination |
| AlSi—Mo—Cr + | to blades and | hydroxide) | present |
| 40 wt. % | reduced grooving in | formation | |
| aromatic | shroud wear track. | | |
| polyester | Average over- | | |
| | penetration*: 22% | | |

*Incursion conditions: 200 m/s blade tip velocity, 150 micron/s incursion rate, room temperature. (0.7 mm blade tip width)

### Additional Examples

Gas atomized near eutectic aluminum silicon powders were mechanically alloyed with submicron fine pure molybdenum (e.g. 1.0 wt. %) and pure Chromium powder (e.g. 1.0 wt. %) by way of an attrition milling process leading to Molybdenum and Chromium layers mechanically alloyed onto powder surfaces. Next, a mechanical blend of mechanically alloyed Al12Si—Mo—Cr with Polyester filler (40 wt. %) is produced and this powder material is then subjected to thermal spraying using APS or HVOF or Combustion spraying

Different compositions (specified below) were sprayed on 17-4PH substrates using atmospheric plasma spray and coatings were tested to find an optimum between abradability (low wear to the TiAl6V4 blade counterpart, low blade pick-up i.e. material transfer from the coating to the blade tip), erosion resistance (resistance to foreign object damage impact) and wet corrosion resistance (resistance to blistering cracks in a wet corrosive medium such as NaCl) functionality.
1. Mechanical blend of Al12Si (gas atomized) and 40 wt. % Polyester
2. Mechanical blend of Al12Si-0.5Mo-0.5Cr (mechanically alloyed) and 40 wt. % Polyester
3. Mechanical blend of Al12Si-1.0Mo-1.0Cr (mechanically alloyed) and 40 wt. % Polyester
4. Mechanical blend of Al12Si-2.0Mo-2.0Cr (mechanically alloyed) and 40 wt. % Polyester
5. Mechanical blend of Al12Si-5.0Mo-5.0Cr (mechanically alloyed) and 40 wt. % Polyester
6. Mechanical blend of Al12Si-10.0Mo (mechanically alloyed) and 40 wt. % Polyester.

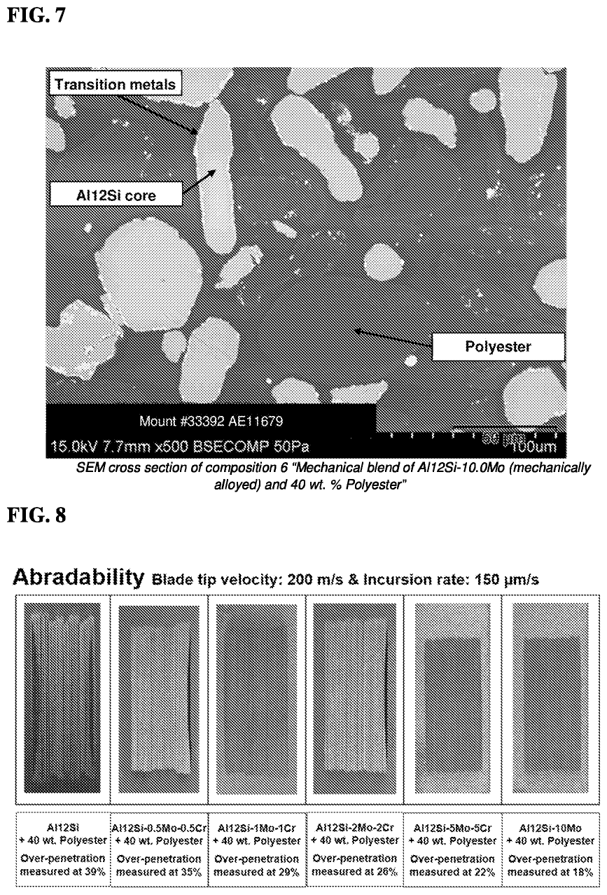

An SEM cross-section of the applied composition 6 is shown in FIG. 7.

The above-noted coatings were subjected to rotor incursion testing that reproduces engine rub conditions in terms of blade tip velocities (up to 500 m/s) and incursion rate of the blade into the abradable coating (up to 2,000 μm/s). The incursion test rig consists of a rotor, a movable specimen stage and a heating device as described in U.S. Pat. No. 7,981,530. Blade wear is displayed in the results as a percentage of total incursion depth. Positive values describe wear whereas negative ones show transfer from the shroud to the blade tip. Therefore, a value of 100 exhibits no incursion into the coating but total blade wear as a consequence. The over-penetration is calculated by measuring the actual incursion depth into the abradable coating divided by the set incursion depth to be reached. The post rub surface roughness was measured using tactile profilometry (Mahr-Perthen Perthometer PRK Surface Profilometer) perpendicular to the abradable coating wear track.

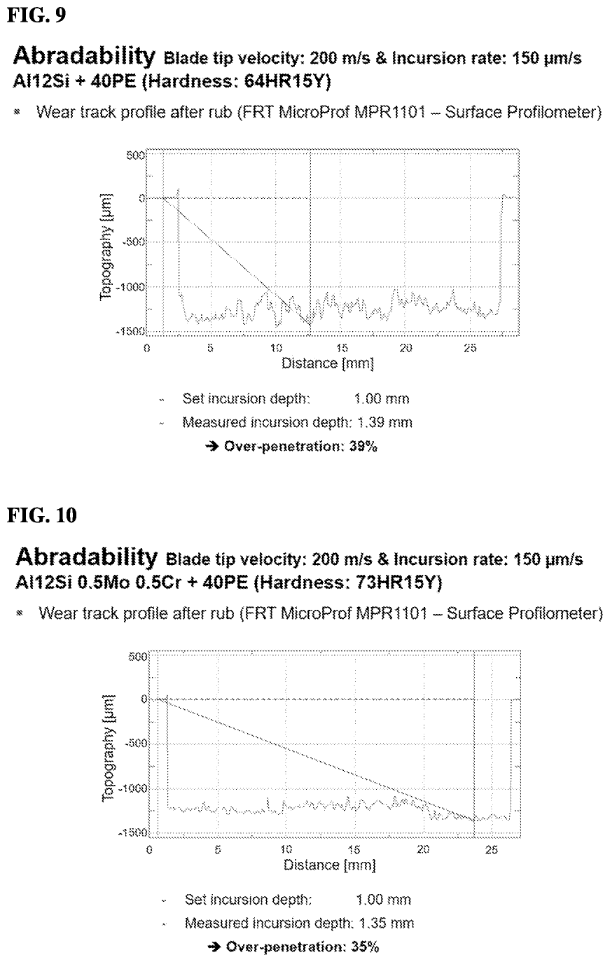

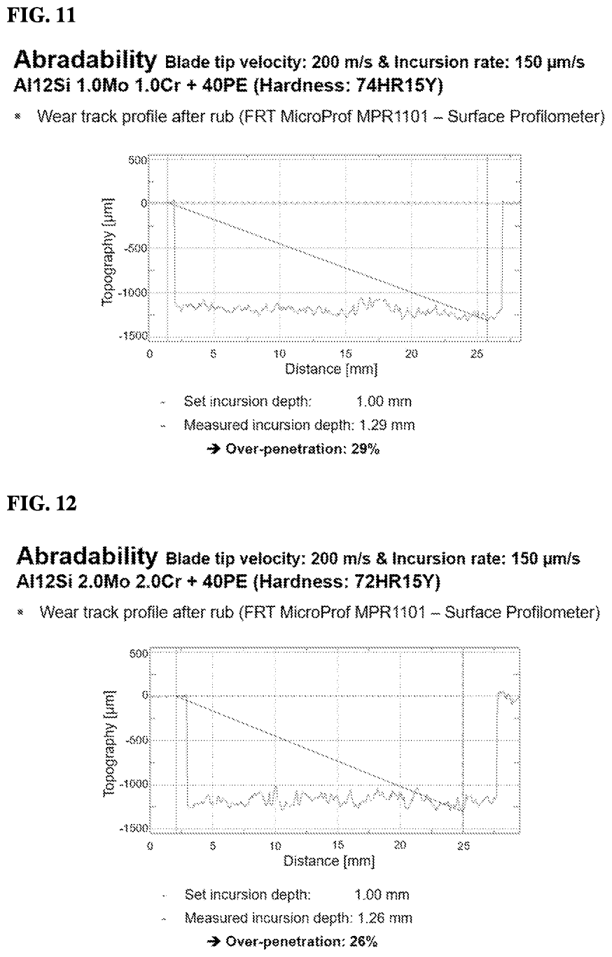

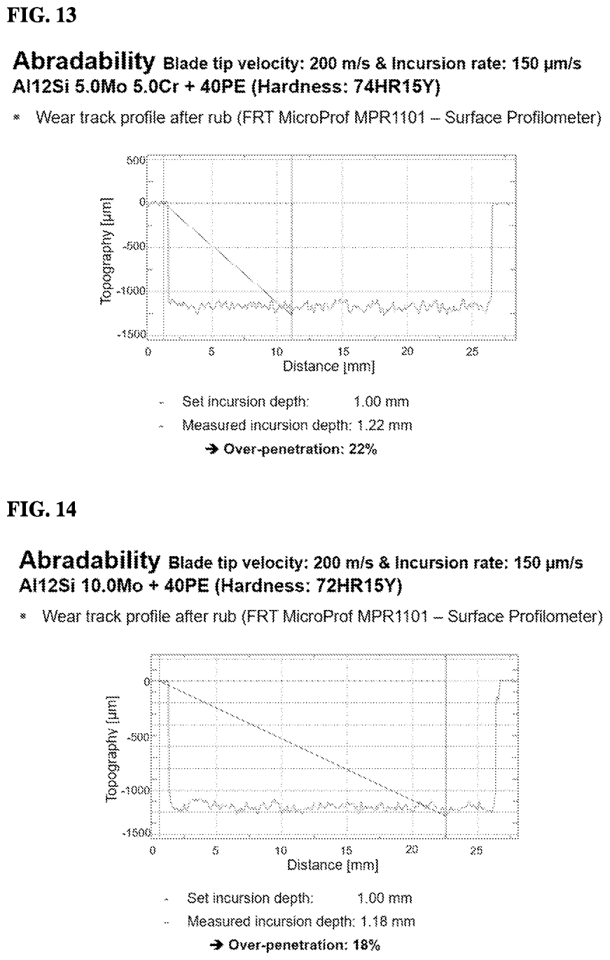

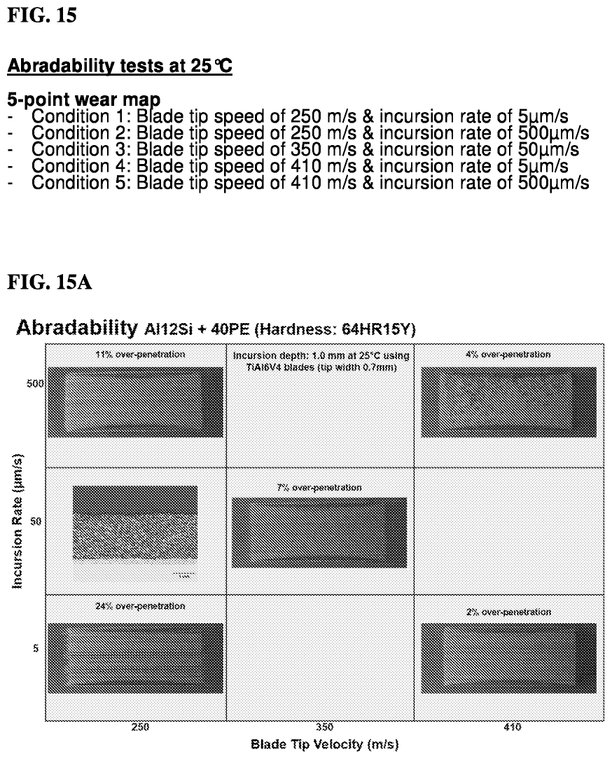

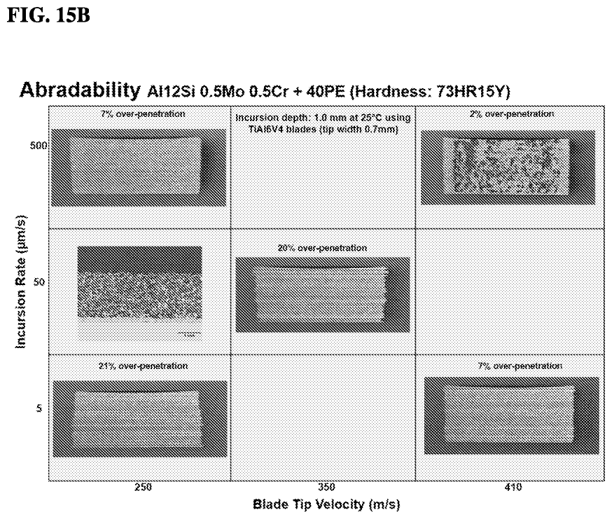

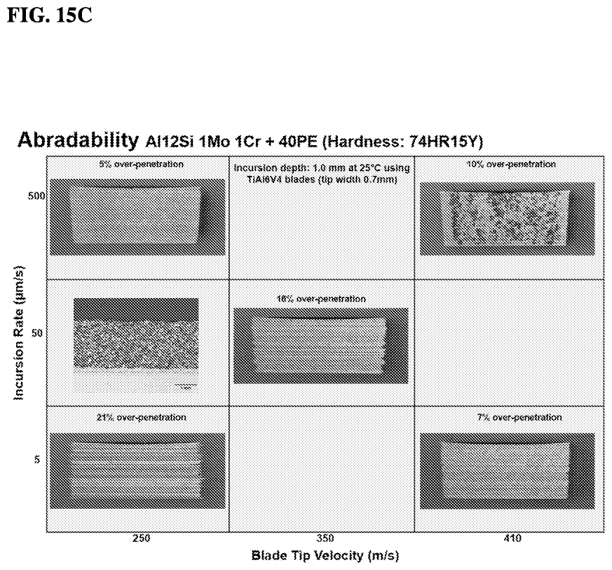

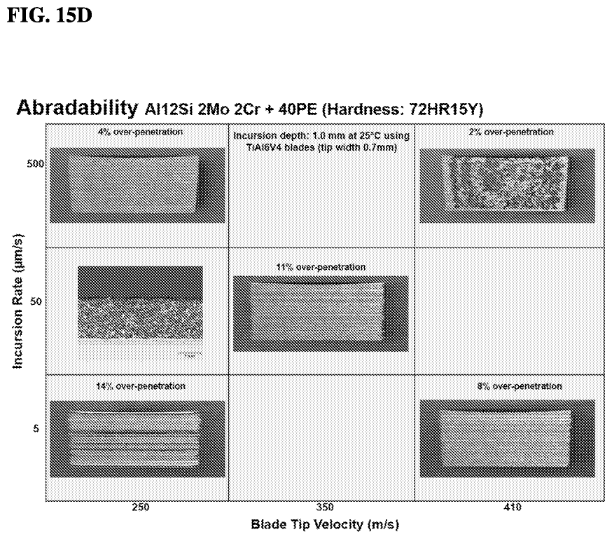

The different data coming from the incursion abradability and corrosion tests are reported in Table B (presented below) and shown in FIGS. 8-15D. From the abradability tests results, one can observe that an increase in the level of transition metal used for mechanical alloying with gas atomized Al12Si leads to lower post-rub surface roughness and associated over-penetration. This confirms that the use of transition elements such as Molybdenum and Chromium mechanically alloyed with an Aluminum alloy allows to reduce the intrinsic tendency of aluminum alloys to adhere and build up on the tip of blades in the case of a rub event, leading to reduced blade pick-up and resulting “gramophoning” effects described previously.

TABLE B

| | Incursion performance | | | | | |
|---|---|---|---|---|---|---|
| | Incursion vs. Ti alloy blades at set | | | | | |
| | incursion condition* | | | | | |
| | Blade | | | Corrosion resistance | | |
| | wear (+) / | | | 200 hours immersion in 5 wt. % | | |
| | Transfer | | Post-rub | aqueous NaCl solution at 40° C. | | |
| | (−) | | surface | | Resistance | Surface |
| Thermally spray | [% of | Over- | roughness | Al | to | roughness |
| abradable coating | inc. | penetration | Ra / Rz | hydroxide | blistering | Ra / Rz |
| composition | depth] | [%] | [μm] | formation | cracks | [μm] |
| 1: Al12Si + | −15.6 | 39.0 | 50.8 / 261.0 | High | Poor | 10.2 / 54.8 |
| 40 wt. % Polyester | | | | | | |
| 2: Al12Si—0.5Mo—0.5Cr + | −18.0 | 35.2 | 22.7 / 127.3 | Low | Good | 3.9 / 23.6 |
| 40 wt. % Polyester | | | | | | |
| 3: Al12Si—1.0Mo—1.0Cr + | −21.3 | 29.2 | 25.3 / 134.0 | Very low | Good | 3.6 / 21.9 |
| 40 wt. % Polyester | | | | | | |
| 4: Al12Si—2.0Mo—2.0Cr + | −20.5 | 26.0 | 36.3 / 182.0 | No | Excellent | 3.6 / 20.0 |
| 40 wt. % Polyester | | | | | | |
| 5: Al12Si—5.0Mo—5.0Cr + | −12.7 | 22.4 | 26.8 / 149.3 | No | Excellent | 3.4 / 19.6 |
| 40 wt. % Polyester | | | | | | |
| 6: Al12Si—10.0Mo + | −14.0 | 20.1 | 18.6 / 104.9 | No | Excellent | 3.0 / 20.3 |
| 40 wt. % Polyester | | | | | | |

*Incursion condition: 200 m/s blade tip velocity, 150 micron/s incursion rate, room temperature, 0.7 mm blade tip thickness

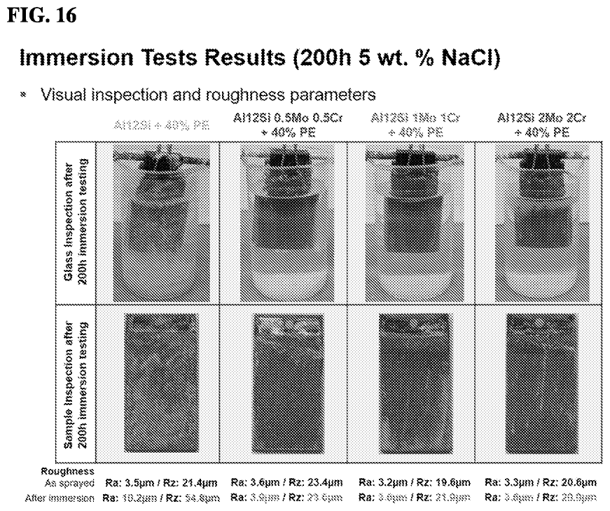

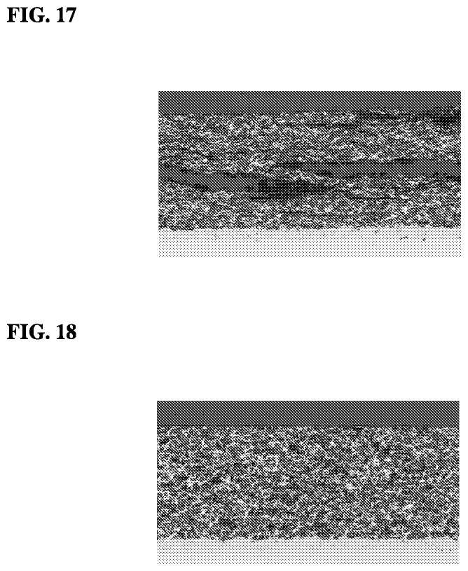

Some of the above-noted coatings were also subjected to immersion Testing (water with 5 wt. % NaCl at 40° C.) and are illustrated in FIG. 16. For the different compositions, some immersion tests in water with 5 wt. % NaCl heated up to 40° C. were conducted for 200 h. From the glass inspection after testing, no formation of Aluminum hydroxide was observed for coatings using Al12Si mechanically alloyed with transition metals such as Chromium and Molybdenum while the benchmark Al12Si-Polyester coatings showed high concentration of Aluminum hydroxide in the glass. The coating inspection after testing showed no formation of corrosion products on the coating surface and no surface roughness increase for coatings using Al12Si mechanically alloyed with transition metals such as Chromium and Molybdenum (see FIG. 18). However, the benchmark Al12Si-Polyester coatings exhibited important surface roughness increase due to formation of corrosion products and resulting blistering cracks (see FIG. 17).

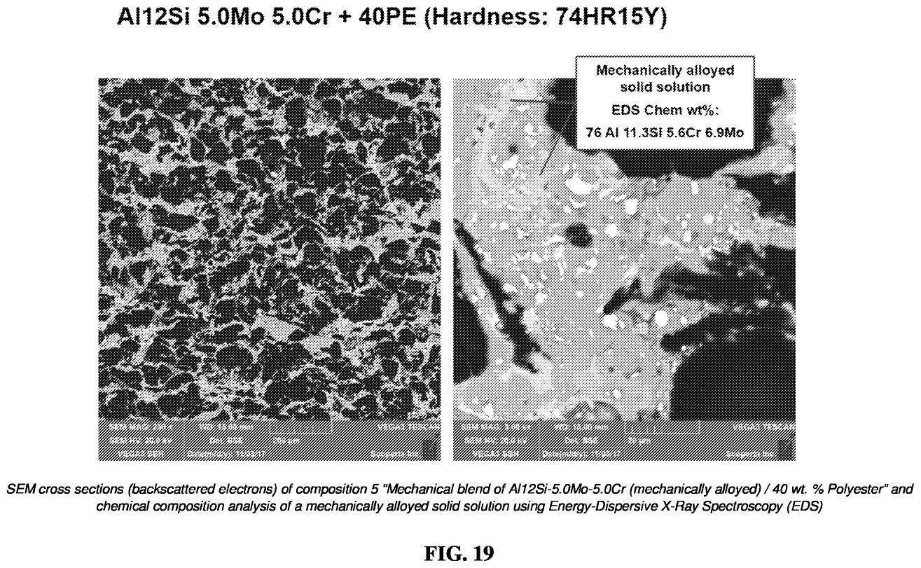

FIG. 19 shows an SEM and EDS analysis at two scales for coating 5 of Table B and illustrates the portions of mechanically alloyed solid solution phase in the coating.

The above-noted coatings 2-6 of Table B are made from an aluminum silicon-polymer powder that produce abradable coatings for clearance control applications where the rotating component may come into contact with the coating as a result of design intent or operational surges. The coatings are designed to minimize the wear to the rotating components while maximizing gas path efficiency by providing clearance control in seal areas.

The powders produce coatings with excellent rub characteristics, i.e., they can provide the optimum balance between the desired properties of abradability, erosion resistance and hardness. They can be specifically designed to meet current gas turbine Original Equipment Manufacturer (OEM) specifications for clearance control coatings. Such coatings 2-6 of Table B made from the powder material that is best applied using an atmospheric plasma spray process. Typical uses and applications include lightweight clearance control coatings for aerospace turbine engine low pressure compressor, automotive and industrial turbochargers. Abradable coatings can be used against untipped titanium alloy and nickel alloy and steel blades at service temperatures up to 325° C. (615° F.) and can also be used against untipped aluminum alloy radial impeller blading. They can have an irregular, rounded morphology and include one or more of the features/properties of Metco 601NS which is herein incorporated by reference in its entirety.

### Other Examples/Possible Uses

A gas atomized near eutectic aluminum silicon powder is mechanically alloyed with submicron fine pure molybdenum and pure Chromium powder by way of an attrition milling process wherein Molybdenum and Chromium layers are mechanically alloyed onto powder surfaces. This composition, which can be any of compositions 2-6 of Table B, is used to manufacturing a wire and the wire is subjected to thermal spraying using a wire spraying (arc or combustion) process. This coating can be used as an abradable coating and/or as a corrosion resistant Aluminum alloy coating.

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A thermal sprayed coating made from aluminum containing particles mechanically alloyed to a transition metal of Molybdenum (Mo) or Chromium (Cr) or a combination of Mo and Cr, said aluminum containing particles comprising a core of aluminum or aluminum alloy coated with the transition metal, said coating comprising aluminum or aluminum alloy portions alloyed to the transition metal.

2. The coating of claim 1, wherein the aluminum alloy comprises aluminum and silicon.

3. The coating of claim 1, wherein the thermal sprayed coating is made from:
organic material blended or mixed or clad with the aluminum containing particles; or
solid lubricant blended or mixed or clad with the aluminum containing particles.

4. The coating of claim 1, wherein the aluminum containing particles comprises a core of pure aluminum.

5. The coating of claim 1, wherein the aluminum containing particles comprises a core of an aluminum alloy.

6. The coating of claim 1, wherein the transition metal is exclusively Molybdenum.

7. The coating of claim 1, wherein the transition metal is exclusively Chromium.

8. The coating of claim 1, wherein the transition metal is exclusively a mixture of Molybdenum and Chromium.

9. The coating of claim 1, wherein the mechanically alloyed transition metal has a particle size that is one of:
below 50 μm Fisher Model 95 Sub-Sieve Sizer (FSSS) measurement; or
below 10 μm (FSSS measurement).

10. A thermal spray powder coating material comprising aluminum containing particles mechanically alloyed to a transition metal of Molybdenum (Mo) or Chromium (Cr) or a combination of Mo and Cr, said aluminum containing particles comprising:
a core of aluminum or aluminum alloy; and
the transition metal mechanically alloyed to the core.

11. The material of claim 10, wherein the aluminum containing particles each comprise an aluminum core or aluminum alloy core that includes silicon surrounded by the transition metal mechanically alloyed to said core.

12. The material of claim 10, wherein the thermal spray powder comprises an organic material or solid lubricant blended or mixed or clad with the aluminum containing particles.

13. The material of claim 10, wherein the aluminum containing particles comprises one of a core of pure aluminum or a core of aluminum alloy.

14. (canceled)

15. (canceled)

16. (canceled)

17. (canceled)

18. The material of claim 10, wherein the mechanically alloyed transition metal has a particle size that is one of:
less than 1 μm;
between 1 μm and 10 μm; or
less than 10 μm.

19. The material of claim 10, wherein the aluminum containing particles are:
blended with 20 to 70 weight percent organic material; or
clad with 20 to 70 weight percent organic material.

20. The material of claim 19, wherein the aluminum containing particles are:
blended with 30 to 50 weight percent organic material; or
clad with 30 to 50 weight percent organic material.

21. The material of claim 19, wherein the organic material is one of:
aromatic polyester;
liquid crystal polyester; or
methyl methacrylate.

22. (canceled)

23. The material of claim 10, wherein the aluminum containing particles are:
blended with 5 to 50 weight percent solid lubricant; or
clad with 5 to 50 weight percent solid lubricant.

24. The material of claim 10, wherein the aluminum containing particles are:
blended with 15 to 25 weight percent solid lubricant; or
clad with 15 to 25 weight percent solid lubricant.

25. The material of claim 23, wherein the solid lubricant is one of:
hexagonal boron nitride; or
calcium fluoride.

26. A method of coating a substrate with a thermal spray powder coating material of claim 10, the method comprising:
thermal spraying the powder material onto the substrate,
wherein thermal spray comprises:
plasma spraying;
high velocity oxy fuel (HVOF);
combustion spraying; or
arc wire spraying.

27-43. (canceled)

44. A thermal sprayed abradable coating made from a thermal spray powder material containing polyester and aluminum containing particles mechanically alloyed to a transition metal of Molybdenum (Mo) and Chromium (Cr), said coating comprising aluminum alloy portions alloyed to the transition metal applied to an engine component, and said engine component is at least one of:
a turbine blade;
a piston ring;
an engine shroud;
an engine cylinder liner;
an engine block; or
a bearing.
